(19) United States
(12) Patent Application Publication
(10) Pub. No.: US 2013/0154469 A1
(43) Pub. Date: Jun. 20, 2013

(54) CATHODE BODY, FLUORESCENT TUBE, AND METHOD OF MANUFACTURING A CATHODE BODY

(71) Applicants: Tadahiro Ohmi, Miyagi (JP); Tetsuya Goto, Miyagi (JP); Hidekazu Ishii, Miyagi (JP)

(72) Inventors: Tadahiro Ohmi, Miyagi (JP); Tetsuya Goto, Miyagi (JP); Hidekazu Ishii, Miyagi (JP)

(73) Assignee: NATIONAL UNIVERSITY CORPORATION TOHOKU UNIVERSITY, Miyagi (JP)

(21) Appl. No.: 13/819,476

(22) PCT Filed: Aug. 30, 2011
(86) PCT No.: PCT/JP2011/069521

§ 371 Date: Feb. 27, 2013

(30) Foreign Application Priority Data
Sep. 1, 2010 (JP) 2010-195878

(51) Int. Cl. H01J 1/30; H01J 9/02

(52) U.S. Cl. CPC H01J 1/30; H01J 9/022
USPC 313/352; 427/126.3; 204/192.15

(57) ABSTRACT

Provided is a cathode body that comprises a cylindrical cup 30 as a base member, a barrier layer 303 provided on a surface of the cylindrical cup 30 and containing SiC, and a film formed on a surface of the barrier layer 303 and containing a boride of a rare earth element and that can prevent interdiffusion of a constituent element of the base member and the boride.

### TECHNICAL FIELD

This invention relates to a cathode body, a fluorescent tube using the cathode body, and a method of manufacturing the cathode body and, in particular, this invention relates to a cathode body comprising a boride film containing a rare earth element, a fluorescent tube using the cathode body comprising the boride film containing the rare earth element, and a method of manufacturing the cathode body comprising the boride film containing the rare earth element.

### BACKGROUND ART

In general, a film of a boride of a rare earth element, such as LaB₆, is used in a cold cathode fluorescent tube or the like which has a cathode body. The cold cathode fluorescent tube with the cathode body is used as a backlight light source of a liquid crystal display device for a monitor, a liquid crystal television, or the like. The cold cathode fluorescent tube comprises a fluorescent tube member in the form of a glass tube having an inner wall coated with a phosphor and a pair of cold electrode members for emitting electrons. A mixed gas such as Hg—Ar is confined in the fluorescent tube member.

Patent Document 1 proposes a cold cathode fluorescent tube which has a cold cathode body of a cylindrical cup shape. Specifically, the cold cathode body of the cylindrical cup shape for electron emission comprises a cylindrical cup formed of nickel and an emitter layer which is composed mainly of a boride of a rare earth element and which is formed on inner and outer wall surfaces of the cylindrical cup. In Patent Document 1, YB₆, GdB₆, LaB₆, and CeB₆ are given as examples of the boride of the rare earth element. The boride of the rare earth element is prepared into a fine powder slurry and is flow-coated on the inner and outer wall surfaces of the cylindrical cup, dried, and sintered, thereby forming the emitter layer.

As described above, in Patent Document 1, the emitter layer is formed by coating the slurry composed mainly of the rare earth element on the cylindrical cup of Ni (nickel), drying the slurry, and sintering the slurry. Specifically, the emitter layer shown in Patent Document 1 is made thin on the open end side of the cylindrical cup and is made thick on the external extraction electrode side.

Normally, the cylindrical cup has an inner diameter of about 0.6 to 1.0 mm and a length of about 2 to 3 mm. Therefore, when the emitter layer is formed by the technique of coating, drying, and sintering the slurry, it is difficult to coat the slurry to a desired thickness. Further, the emitter layer obtained by coating, drying, and sintering the slurry is insufficient in adhesion with Ni and it is difficult to completely remove an organic substance, moisture, and oxygen contained in a binder. As a result, in Patent Document 1, it is difficult to obtain a cold cathode body with high brightness and long lifetime.

On the other hand, Patent Document 2 discloses that a cold cathode body of a cylindrical cup shape is formed by mixing a material selected from La₂O₃, ThO₂, and Y₂O₃ with a material having high thermal conductivity, such as tungsten. The cold cathode body of the cylindrical cup shape shown in Patent Document 2 is formed by, for example, injection molding, i.e. MIM (Metal Injection Molding), of a tungsten alloy powder containing La₂O₃. In this case, in Patent Document 2, it is disclosed that the cold cathode body of the cylindrical cup shape is formed by injection-molding, in a mold, pellets which are obtained by mixing the tungsten alloy powder containing La₂O₃ with a resin such as styrene.

Using the high thermal conductivity material such as tungsten as disclosed in Patent Document 2 makes it possible to improve thermal conduction in the cold cathode body and to achieve a longer lifetime of the cold cathode body. However, the cold cathode body is insufficient in electron emission characteristics. Therefore, in Patent Document 2, it is difficult to obtain a cold cathode body with high brightness and high efficiency.

Further, Patent Document 3 discloses a discharge cathode device for use in a plasma display panel. The discharge cathode device comprises, on a glass substrate, an aluminum layer formed as a base electrode and a LaB₆ layer formed on the aluminum layer. The aluminum layer is formed on the glass substrate maintained at a predetermined temperature by sputtering, vacuum vapor deposition, or ion plating while the LaB₆ layer is formed on the aluminum layer by sputtering or the like.

As described above, Patent Document 3 discloses that a discharge cathode pattern comprising the LaB₆ layer and the aluminum layer is formed on the glass substrate by sputtering.

However, this technique assumes that the aluminum layer and the LaB₆ layer are formed on the glass substrate of a flat shape by sputtering. Nothing is disclosed about a technique of sputtering on the cold cathode body of the concavo-convex cylindrical cup shape. Further, Patent Document 3 discloses nothing about forming the LaB₆ layer with high adhesion on a material other than the glass substrate without interposing the aluminum layer therebetween. Moreover, Patent Document 3 points out nothing about improving the electron emission efficiency of the cold cathode body of the cylindrical cup shape.

On the other hand, Patent Document 4 discloses a technique of sputtering on a cold cathode body having a cylindrical cup shape. Specifically, Patent Document 4 proposes that a film of a boride of a rare earth element is formed by sputtering by the use of a rotary magnet type magnetron sputtering apparatus.

The rotary magnet type magnetron sputtering apparatus used in Patent Document 4 is configured to move ring-shaped plasma regions on a target with time so that it is possible to prevent local wear of the target and further to increase the plasma density to thereby improve the film forming rate. This rotary magnet type magnetron sputtering apparatus has a structure in which the target is faced towards a workpiece substrate and magnet members are disposed on the side opposite to the workpiece substrate with respect to the target.

The magnet members of the rotary magnet type magnetron sputtering apparatus comprise a rotary magnet group having a plurality of plate magnets helically bonded to a surface of a rotary shaft and a fixed outer peripheral plate magnet which is disposed around the rotary magnet group in parallel to a surface of the target and is magnetized perpendicularly to the target. According to this structure, by rotating the rotary magnet group, a magnetic field pattern which appears on the target by both the rotary magnet group and the fixed outer peripheral plate magnet is continuously moved in a direction of the rotary shaft so that it is possible to continuously move plasma regions on the target in the direction of the rotary shaft with time.

### Prior Art Document

### Patent Document

Patent Document 1: JP-A-H10-144255

Patent Document 2: WO 2004/075242

Patent Document 3: JP-A-H5-250994

Patent Document 4: WO 2009/035074

### SUMMARY OF THE INVENTION

### Problem to be Solved by the Invention

The rotary magnet type magnetron sputtering apparatus described in Patent Document 4 is a technique which is quite excellent in that it can use the target uniformly for a long time, that it can improve the film forming rate, that it can manufacture a cold cathode body with excellent electron emission characteristics and long lifetime, and that it can easily carry out film formation even if the cathode body has a cylindrical cup shape.

With a cathode body, i.e. a cathode body made only or mainly of W and covered with a LaB₆ layer, which is formed using the rotary magnet type magnetron sputtering apparatus as described in Patent Document 4, insufficient points have still been found depending on the use. For example, there is the case where if a predetermined temperature is exceeded while using the cathode body, interdiffusion of the constituent elements between the LaB₆ layer and the W base member occurs so that the composition of the LaB₆ layer cannot be maintained, resulting in that the function and characteristics of the LaB₆ layer cannot be exhibited. If this problem is improved, it is possible to obtain a further preferable cathode body.

Therefore, it is a technical object of this invention to provide a cathode body that comprises a film of a boride of a rare earth element and that can prevent interdiffusion of constituent elements between a base member and the film.

### Means for Solving the Problem

According to a first aspect of this invention, there is provided a cathode body characterized by comprising a base member, a barrier layer provided on a surface of the base member and containing SiC, and a film formed on a surface of the barrier layer and containing a boride of a rare earth element.

The base member may be of tungsten, molybdenum, silicon, or tungsten or molybdenum which contains at least one selected from the group consisting of La₂O₃, ThO₂, and Y₂O₃. In particular, the base member may be of tungsten or molybdenum containing 4 to 6% La₂O₃ by volume ratio.

Furthermore, the boride of the rare earth element may contain at least one boride selected from the group consisting of LaB₄, LaB₆, YbB₆, GaB₆, and CeB₆.

According to this invention, there is provided a method of manufacturing a cathode body, characterized by comprising a step (a) of forming a barrier layer containing SiC on a surface of a base member and a step (b) of forming a film containing a boride of a rare earth element on the barrier layer. The base member may be of tungsten, molybdenum, silicon, or tungsten or molybdenum containing 4 to 6 wt % lanthanum oxide.

### EFFECT OF THE INVENTION

According to this invention, it is possible to provide a cathode body that comprises a film of a boride of a rare earth element and that can prevent interdiffusion of constituent elements between a base member and the film.

### BRIEF DESCRIPTION OF THE DRAWINGS

FIG. 1 is a schematic diagram showing one example of a magnetron sputtering apparatus for use in the manufacture of a cathode body according to this invention.

FIG. 2 is a cross-sectional view showing, on an enlarged scale, a part of the cathode body according to this invention.

FIG. 3 is graphs showing compositions of samples of Examples 1 to 3 in a depth direction thereof.

FIG. 4 is electron micrographs of cross-sections of the samples of Examples 1 to 3.

FIG. 5 is graphs showing compositions of samples of Examples 4 to 6 in a depth direction thereof.

FIG. 6 is electron micrographs of cross-sections of the samples of Examples 4 to 6.

FIG. 7 is graphs showing compositions of samples of Examples 7 to 9 in a depth direction thereof.

FIG. 8 is graphs showing compositions of samples of Examples 10 to 12 in a depth direction thereof.

FIG. 9 is graphs showing compositions of samples of Examples 13 to 15 in a depth direction thereof.

FIG. 10 is graphs showing compositions of samples of Examples 16 to 18 in a depth direction thereof.

FIG. 11 is graphs showing compositions of samples of Comparative Examples 1 and 2 in a depth direction thereof.

FIG. 12 is graphs showing compositions of samples of Comparative Examples 3 and 4 in a depth direction thereof.

FIG. 13 is electron micrographs of cross-sections of the samples of Comparative Examples 1 and 2.

FIG. 14 is electron micrographs of cross-sections of the samples of Comparative Examples 3 and 4.

### MODE FOR CARRYING OUT THE INVENTION

Hereinbelow, a preferred embodiment of this invention will be described in detail with reference to the drawings.

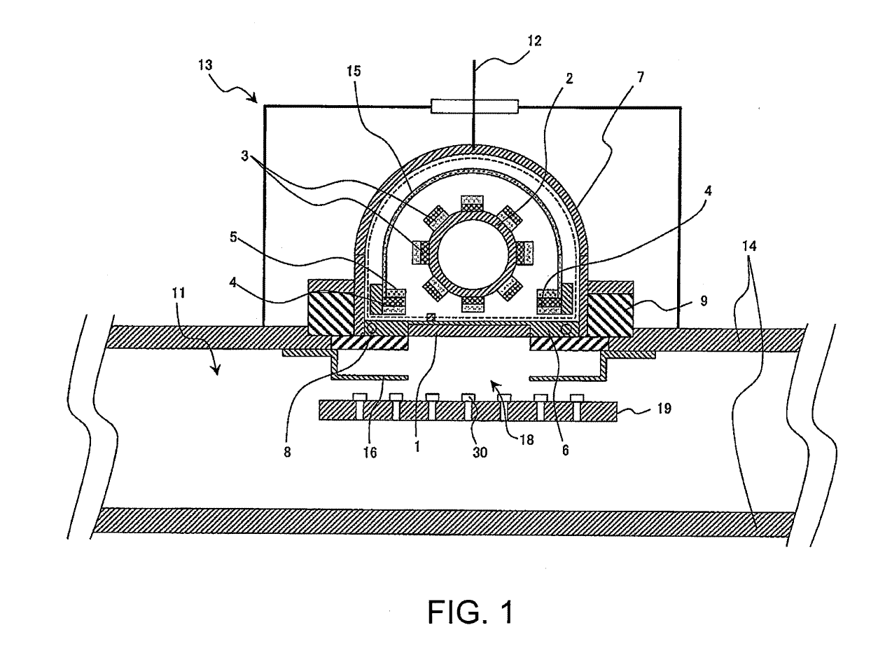

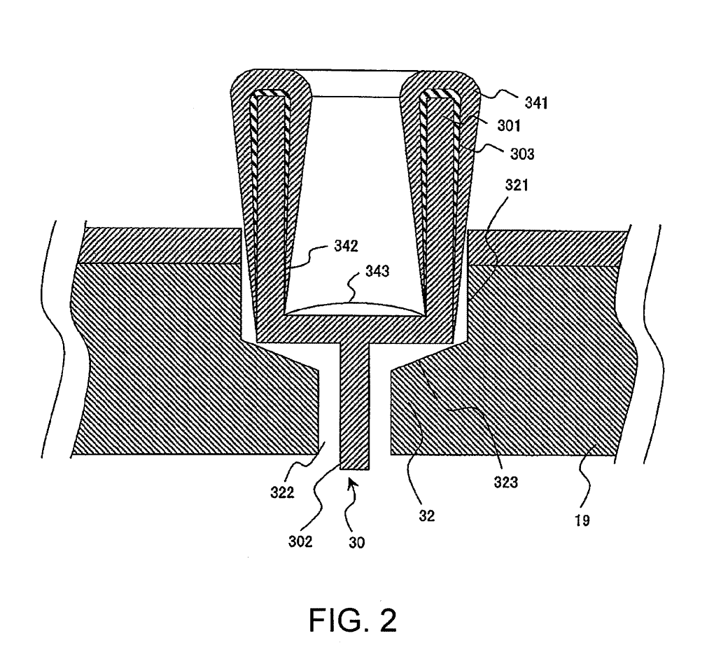

FIG. 1 is a diagram showing one example of a rotary magnet type magnetron sputtering apparatus for use in this invention and FIG. 2 is a diagram for explaining a cathode body according to this invention and a cathode body manufacturing jig 19 for use in the manufacture of the cathode body.

The rotary magnet type magnetron sputtering apparatus shown in FIG. 1 comprises a target 1, a columnar rotary shaft 2 having a polygonal shape (e.g. a regular hexadecagonal shape), a rotary magnet group 3 comprising a plurality of helical plate magnet groups helically bonded to a surface of the columnar rotary shaft 2, a fixed outer peripheral plate magnet 4 disposed around the rotary magnet group 3 so as to surround the rotary magnet group 3, and an outer peripheral paramagnetic member 5 disposed on the side opposite to the target 1 with respect to the fixed outer peripheral plate magnet 4. That is, the illustrated rotary magnet type magnetron sputtering apparatus has the structure in which the single fixed outer peripheral plate magnet 4 is provided so as to surround the single rotary magnet group 3.

Further, a backing plate 6 is bonded to the target 1. The columnar rotary shaft 2 and the helical plate magnet groups are covered with a paramagnetic member 15 at portions thereof other than on the target 1 side. Further, the paramagnetic member 15 is covered with a housing 7.

As seen from the target 1, the fixed outer peripheral plate magnet 4 is configured to surround in a loop shape the rotary magnet group 3 comprising the helical plate magnet groups. Herein, the fixed outer peripheral plate magnet 4 is magnetized so that an S-pole is faced towards the target 1 side thereof. The fixed outer peripheral plate magnet 4 and the plate magnets of the helical plate magnet groups are each formed by a Nd—Fe—B-based sintered magnet.

Further, within an illustrated space 11 inside a process chamber, a plasma shielding member 16 is placed and the cathode body manufacturing jig 19 is disposed. The space 11 is evacuated and a plasma gas is introduced therein.

The illustrated plasma shielding member 16 extends in an axial direction of the columnar rotary shaft 2 and defines a slit 18 which opens the target 1 towards the cathode body manufacturing jig 19. A region which is not shielded by the plasma shielding member 16, i.e. a region which is opened to the target 1 by the slit 18, is a region where the magnetic field strength is high and thus a high-density, low-electron-temperature plasma is generated so that cathode members disposed on the cathode body manufacturing jig 19 are free from charge-up damage and ion irradiation damage, and simultaneously where the film forming rate is high. By shielding regions other than this region by the plasma shielding member 16, film formation free from damage is enabled without substantially reducing the film forming rate.

The backing plate 6 has a coolant passage 8 for allowing a coolant to pass therethrough. An insulating member 9 is provided between the housing 7 and an outer wall 14 defining the process chamber. A feeder line 12 connected to the housing 7 is drawn out to the outside through a cover 13. A DC power supply, a RF power supply, and a matching unit (not illustrated) are connected to the feeder line 12.

With this structure, a plasma excitation power is supplied to the backing plate 6 and the target 1 from the DC power supply and the RF power supply through the matching unit, the feeder line 12, and the housing 7 so that plasma is excited on a surface of the target 1. While it is possible to excite plasma only by a DC power or only by a RF power, it is preferable to apply both DC and RF powers in terms of film quality controllability and film forming rate controllability. The frequency of the RF power is normally selected between several hundred kHz and several hundred MHz. A higher frequency is desirable in terms of an increase in density and a reduction in electron temperature of plasma. In this embodiment, a frequency of 13.56 MHz is practically used.

As shown in FIG. 1, a plurality of cylindrical cups 30, each of which forms a cathode body, are attached to the cathode body manufacturing jig 19 disposed in the process chamber space 11.

Referring also to FIG. 2, the cathode body manufacturing jig 19 has a plurality of support portions 32 supporting the cylindrical cups 30. Herein, as shown in FIG. 2, each cylindrical cup 30 has a cylindrical electrode portion 301 and a lead portion 302 drawn out from the center of a bottom portion of the cylindrical electrode portion 301 in a direction opposite to the cylindrical electrode portion 301. In this example, it is assumed that the cylindrical electrode portion 301 and the lead portion 302 are integrally molded by, for example, MIM (Metal Injection Molding) or the like.

Each support portion 32 of the cathode body manufacturing jig 19 has a receiving portion 321 defining an opening having a size for receiving the cylindrical electrode portion 301 of the cylindrical cup 30, a flange portion 322 defining a hole having a diameter smaller than that of the receiving portion 321, and an inclined portion 323 connecting between the receiving portion 321 and the flange portion 322. As illustrated, the cylindrical electrode portion 301 is inserted into and positioned in the support portion 32 of the cathode body manufacturing jig 19. Specifically, the lead portion 302 of the cylindrical electrode portion 301 passes through the flange portion 322 of the cathode body manufacturing jig 19 while an outer end of the cylindrical electrode portion 301 is in contact with the inclined portion 323 of the cathode body manufacturing jig 19.

Herein, the illustrated cylindrical cup 30 is formed of tungsten (W) containing 4% to 6% lanthanum oxide (La₂O₃) by volume ratio and has the cylindrical electrode portion 301 having an inner diameter of 1.4 mm, an outer diameter of 1.7 mm, and a length of 4.2 mm. On the other hand, the length of the lead portion 302 of the cylindrical cup 30 may be set to as short as, for example, about 1.0 mm. In this example, the cylindrical cup 30 is formed by mixing tungsten which is a fireproof metal having excellent thermal conductivity with La₂O₃ having a work function as small as 2.8 to 4.2 eV. By using tungsten, heat generated in the cylindrical cup 30 can be efficiently discharged. By mixing lanthanum oxide having the small work function, electrons can be emitted also from the cylindrical cup 30 itself. As a metal with high thermal conductivity for forming the cylindrical cup 30, molybdenum (Mo) may be used instead of tungsten.

Herein, a method of manufacturing the cylindrical cup 30 will be described in detail. First, a tungsten alloy powder containing 3% La₂O₃ by volume ratio was mixed with a resin powder. Styrene was used as the resin powder. The mixing ratio of the tungsten alloy powder and styrene was 0.5:1 by volume ratio. Then, a very small amount of Ni was added as a sintering assistant, thereby obtaining pellets. Using the pellets thus obtained, injection molding (MIM) was carried out in a mold having a cylindrical cup shape at a temperature of 150° C., thereby manufacturing a cup-shaped molded product. The molded product thus manufactured was heated in a hydrogen atmosphere to be degreased. Thus, the cylindrical cup 30 was obtained.

Then, the cylindrical cup 30 was fixed to the cathode body manufacturing jig 19 shown in FIGS. 1 and 2 and carried into the process chamber space 11 of the rotary magnet type magnetron sputtering apparatus in which a SiC sintered body (a later-described low-resistance product) was set as the target 1. Argon was introduced into the process chamber space 11 at a gas flow rate of 2 SLM and the cathode body manufacturing jig 19 was heated to a temperature of 300° C. at a pressure of 15 mTorr, thereby carrying out sputtering to form a SiC film 303.

SLM is an abbreviation of Standard Liters per Minute and is a unit representing, in liter, a flow rate per minute at 0° C. at 1 atm (1.01325×10⁵ Pa).

Then, the cylindrical cup 30 was fixed to the cathode body manufacturing jig 19 shown in FIGS. 1 and 2 and carried into the process chamber space 11 of the rotary magnet type magnetron sputtering apparatus in which a LaB₆ sintered body was set as the target 1.

Argon was introduced into the process chamber space 11, the pressure was set to about 20 mTorr (2.7 Pa), and the cathode body manufacturing jig 19 was heated to a temperature of 300° C., thereby carrying out sputtering to form a LaB₆ film 341 on the SiC film 303.

Referring back to FIG. 2, a state of the cylindrical cup 30 after the sputtering is exemplarily shown. As illustrated, a thick LaB₆ film 341 is formed in a region where the aspect ratio as a ratio between the depth and the inner diameter of the cylindrical electrode portion 301 is 1 while a thin LaB₆ film 342 is formed in a portion located below such a region with respect to the cathode body manufacturing jig 19. Further, a very thin LaB₆ film (bottom LaB₆ film 343) is formed on an inner bottom surface of the cylindrical electrode portion 301.

Further, the barrier layer 303 containing SiC is formed between the LaB₆ films and the cylindrical electrode portion 301. Specifically, the barrier layer 303 is formed on a surface of the cylindrical electrode portion 301 and the LaB₆ films are each formed on a surface of the barrier layer 303.

The barrier layer 303 is a layer for preventing interdiffusion between the material (herein, W) forming the cylindrical electrode portion 301 and the LaB₆ films. By providing the barrier layer 303, the composition of the LaB₆ layer is maintained.

The material forming the barrier layer 303 preferably contains SiC. This is because, as will be described later, with this material, interdiffusion hardly occurs between the LaB₆ films and W and further the amount of diffusion hardly changes depending on the temperature.

In the illustrated example, the thick LaB₆ film 341, the thin LaB₆ film 342, and the bottom LaB₆ film 343 had thicknesses of 300 nm, 60 nm, and 10 nm, respectively, and the barrier layer 303 had a thickness of 50 nm. In terms of preventing diffusion, the barrier layer 303 forming the SiC film should have a certain thickness. However, in terms of suppressing the resistance of an electrode, the thickness is preferably set to about 10 to 100 nm.

Through experiments by the present inventors, it was confirmed that the cathode body having the above-mentioned LaB₆ films could maintain high efficiency and high brightness over a long time.

### EXAMPLES

Hereinbelow, this invention will be described in detail with reference to Examples.

In the following manner, the degrees of diffusion of elements between W and SiC and between LaB₆ and SiC were measured and the presence or absence of a diffusion preventing function of SiC as a barrier layer 303 was evaluated.

### Preparation of Samples

### Example 1

As SiC, a CVD-formed silicon carbide (CVD-SiC) substrate (8 mm×20 mm, thickness 0.725 mm) was prepared. Using a LaB₆ sintered body as a target of a rotary magnet type magnetron sputtering apparatus, a LaB₆ film was formed to 200 nm on the substrate under conditions of a pressure of 50 mTorr and an Ar gas flow rate of 2 SLM. Thereafter, using an infrared heating furnace, a heat treatment was carried out as a baking treatment at an atmospheric pressure, at an Ar flow rate of 2 SLM, and at 300° C. for 30 minutes, thereby preparing a sample.

### Example 2

Using an infrared heating furnace, the sample of Example 1 was heated as an annealing treatment at an atmospheric pressure, at an Ar flow rate of 2 SLM, and at 1000° C. for 60 minutes, thereby preparing a sample.

### Example 3

Using an infrared heating furnace, the sample of Example 1 was heated as an annealing treatment at an atmospheric pressure, at an Ar flow rate of 2 SLM, and at 1100° C. for 60 minutes, thereby preparing a sample.

### Example 4

As SiC, a CVD-formed silicon carbide (CVD-SiC) substrate (8 mm×20 mm, thickness 0.725 mm) was prepared. Using W as a target of a rotary magnet type magnetron sputtering apparatus, a W film was formed to 200 nm on the substrate under conditions of a pressure of 10 mTorr and an Ar gas flow rate of 322 sccm. Thereafter, using an infrared heating furnace, a heat treatment was carried out as a baking treatment at an atmospheric pressure, at an Ar flow rate of 2 SLM, and at 300° C. for 30 minutes, thereby preparing a sample.

### Example 5

Using an infrared heating furnace, the sample of Example 4 was heated as an annealing treatment at an atmospheric pressure, at an Ar flow rate of 2 SLM, and at 1000° C. for 60 minutes, thereby preparing a sample.

### Example 6

Using an infrared heating furnace, the sample of Example 4 was heated as an annealing treatment at an atmospheric pressure, at an Ar flow rate of 2 SLM, and at 1100° C. for 60 minutes, thereby preparing a sample.

### Example 7

As SiC, a substrate (8 mm×20 mm, thickness 3 mm) of ceramic silicon carbide (SiC sintered body) S452 (high-resistance product, resistivity 66 to 1300 Ω·cm) manufactured by Sumitomo Osaka Cement was prepared. Using LaB₆ as a target of a rotary magnet type magnetron sputtering apparatus, a LaB₆ film was formed to 200 nm on the substrate under conditions of a pressure of 50 mTorr and an Ar gas flow rate of 2 SLM. Thereafter, using an infrared heating furnace, a heat treatment was carried out as a baking treatment at an atmospheric pressure, at an Ar flow rate of 2 SLM, and at 300° C. for 30 minutes, thereby preparing a sample.

### Example 8

Using an infrared heating furnace, the sample of Example 7 was heated as an annealing treatment at an atmospheric pressure, at an Ar flow rate of 2 SLM, and at 1000° C. for 60 minutes, thereby preparing a sample.

### Example 9

Using an infrared heating furnace, the sample of Example 7 was heated as an annealing treatment at an atmospheric pressure, at an Ar flow rate of 2 SLM, and at 1100° C. for 60 minutes, thereby preparing a sample.

### Example 10

As SiC, a substrate (8 mm×20 mm, thickness 3 mm) of ceramic silicon carbide (SiC sintered body) S312 (low-resistance product, resistivity 0.024 to 0.030 Ω·cm) manufactured by Sumitomo Osaka Cement was prepared. Using LaB₆ as a target of a rotary magnet type magnetron sputtering apparatus, a LaB₆ film was formed to 200 nm on the substrate under conditions of a pressure of 50 mTorr and an Ar gas flow rate of 2 SLM. Thereafter, using an infrared heating furnace, a heat treatment was carried out as a baking treatment at an atmospheric pressure, at an Ar flow rate of 2 SLM, and at 300° C. for 30 minutes, thereby preparing a sample.

### Example 11

Using an infrared heating furnace, the sample of Example 10 was heated as an annealing treatment at an atmospheric pressure, at an Ar flow rate of 2 SLM, and at 1000° C. for 60 minutes, thereby preparing a sample.

### Example 12

Using an infrared heating furnace, the sample of Example 10 was heated as an annealing treatment at an atmospheric pressure, at an Ar flow rate of 2 SLM, and at 1100° C. for 60 minutes, thereby preparing a sample.

### Example 13

As SiC, a substrate (8 mm×20 mm, thickness 3 mm) of ceramic silicon carbide (SiC sintered body) S452 manufactured by Sumitomo Osaka Cement was prepared. Using W as a target of a rotary magnet type magnetron sputtering apparatus, a W film was formed to 200 nm on the substrate under conditions of a pressure of 10 mTorr and an Ar gas flow rate of 322 sccm. Thereafter, using an infrared heating furnace, a heat treatment was carried out as a baking treatment at an atmospheric pressure, at an Ar flow rate of 2 SLM, and at 300° C. for 30 minutes, thereby preparing a sample.

### Example 14

Using an infrared heating furnace, the sample of Example 13 was heated as an annealing treatment at an atmospheric pressure, at an Ar flow rate of 2 SLM, and at 1000° C. for 60 minutes, thereby preparing a sample.

### Example 15

Using an infrared heating furnace, the sample of Example 13 was heated as an annealing treatment at an atmospheric pressure, at an Ar flow rate of 2 SLM, and at 1100° C. for 60 minutes, thereby preparing a sample.

### Example 16

As SiC, a substrate (8 mm×20 mm, thickness 3 mm) of ceramic silicon carbide (SiC sintered body) S312 manufactured by Sumitomo Osaka Cement was prepared. Using W as a target of a rotary magnet type magnetron sputtering apparatus, a W film was formed to 200 nm on the substrate under conditions of a pressure of 10 mTorr and an Ar gas flow rate of 322 sccm. Thereafter, using an infrared heating furnace, a heat treatment was carried out as a baking treatment at an atmospheric pressure, at an Ar flow rate of 2 SLM, and at 300° C. for 30 minutes, thereby preparing a sample.

### Example 17

Using an infrared heating furnace, the sample of Example 10 was heated as an annealing treatment at an atmospheric pressure, at an Ar flow rate of 2SLM, and at 1000° C. for 60 minutes, thereby preparing a sample.

### Example 18

Using an infrared heating furnace, the sample of Example 10 was heated as an annealing treatment at an atmospheric pressure, at an Ar flow rate of 2 SLM, and at 1100° C. for 60 minutes, thereby preparing a sample.

### Comparative Example 1

Using W as a target of a rotary magnet type magnetron sputtering apparatus, a W film was formed to 90 nm on a Si substrate formed with a SiO₂ oxide film, under conditions of a pressure of 10 mTorr and an Ar gas flow rate of 322 sccm. Further, using LaB₆ as a target of a rotary magnet type magnetron sputtering apparatus, a LaB₆ film was formed to 90 nm under conditions of a pressure of 50 mTorr and an Ar gas flow rate of 2 SLM. That is, a barrier layer 303 was not provided between W and LaB₆. Then, baking was carried out by heating at 300° C. for 30 minutes under a condition of an Ar flow rate of 2 SLM.

### Comparative Example 2

Using an infrared heating furnace, the sample of Comparative Example 1 was annealed by heating at 1000° C. for 60 minutes under conditions of an atmospheric pressure and an Ar flow rate of 2 SLM.

### Comparative Example 3

Using an infrared heating furnace, the sample of Comparative Example 1 was annealed by heating at 1050° C. for 60 minutes under conditions of an atmospheric pressure and an Ar flow rate of 2 SLM.

### Comparative Example 4

Using an infrared heating furnace, the sample of Comparative Example 1 was annealed by heating at 1100° C. for 60 minutes under conditions of an atmospheric pressure and an Ar flow rate of 2 SLM.

### Diffusion Evaluation Test

Then, the degrees of interdiffusion of the samples of Examples 1 to 18 and Comparative Examples 1 to 4 were measured.

As composition analysis, composition analysis in a depth direction of the samples was carried out by ESCA (Electron Spectroscopy for Chemical Analysis) using JPS-9010MX manufactured by JEOL Ltd. (JEOL).

Further, cross-sectional observation was carried out for Examples 1 to 6 and Comparative Examples 1 to 4. Specifically, after cutting the samples, observation was carried out at 50000 magnifications using JSM-6700F manufactured by JEOL Ltd. (JEOL).

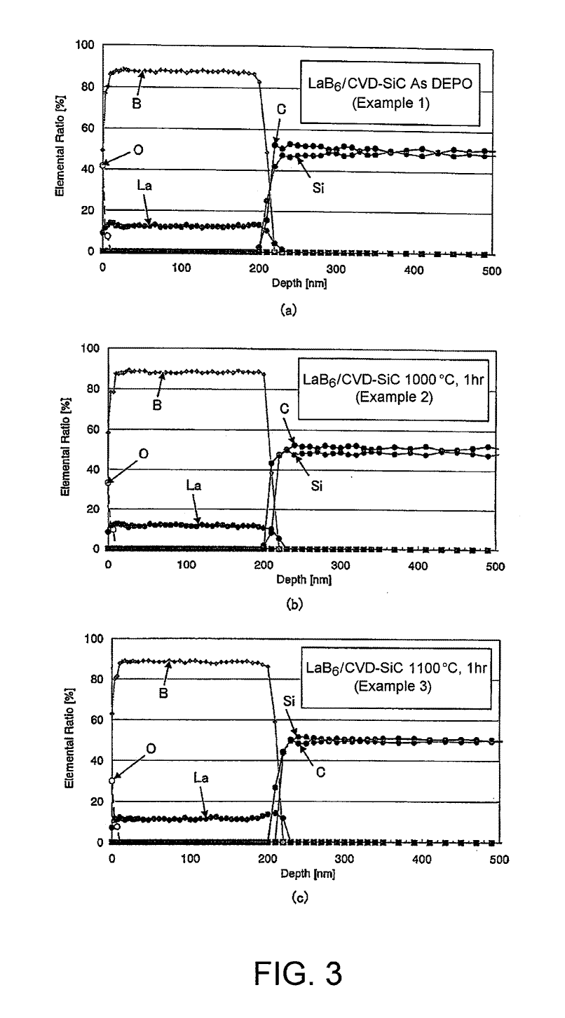

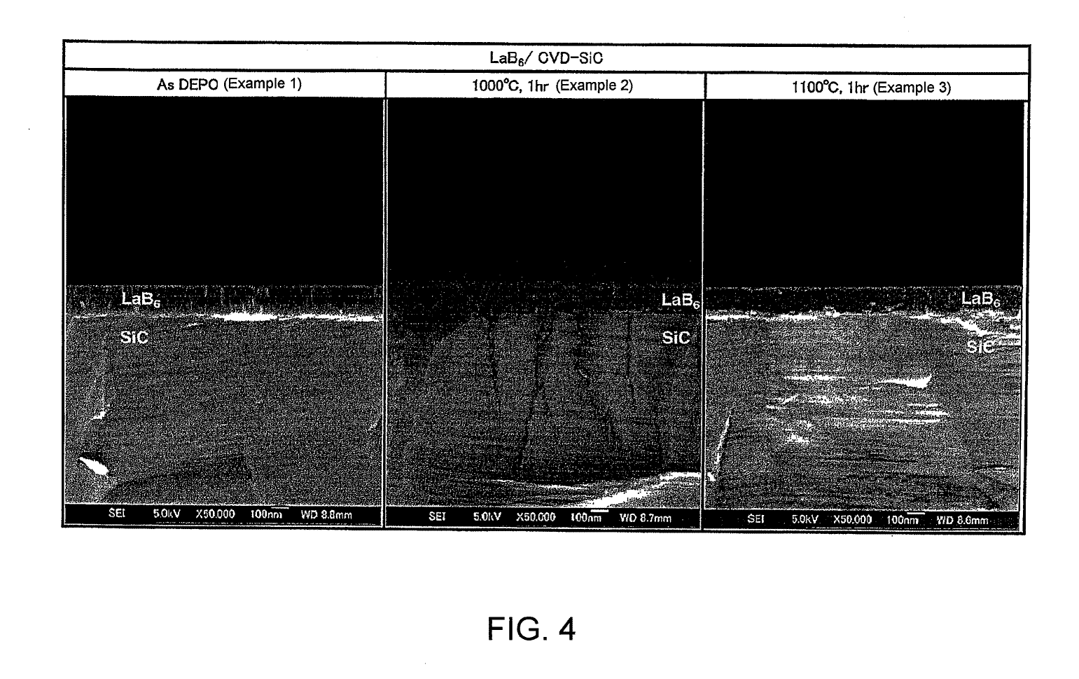

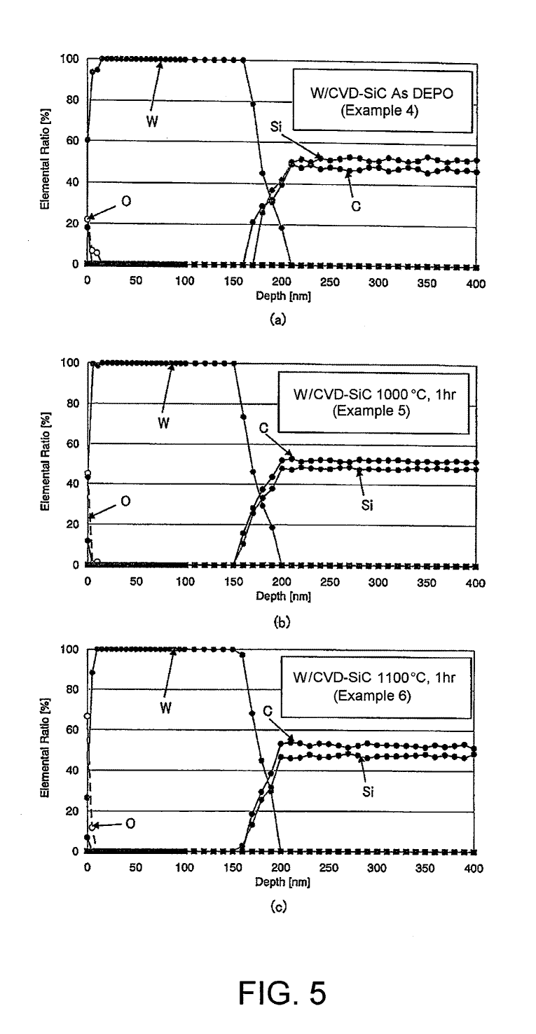

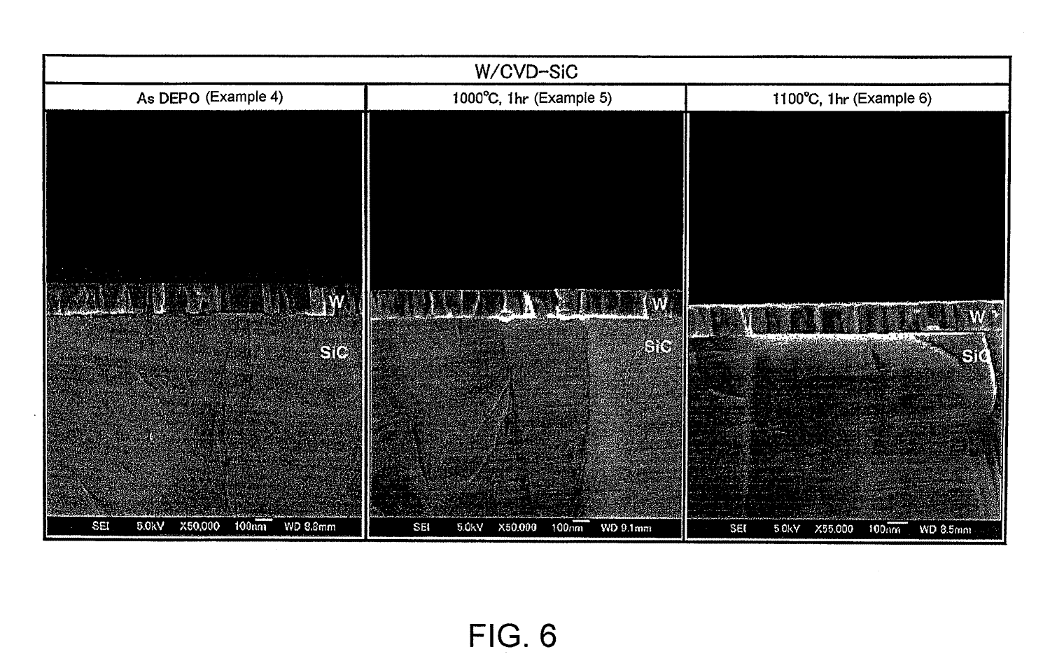

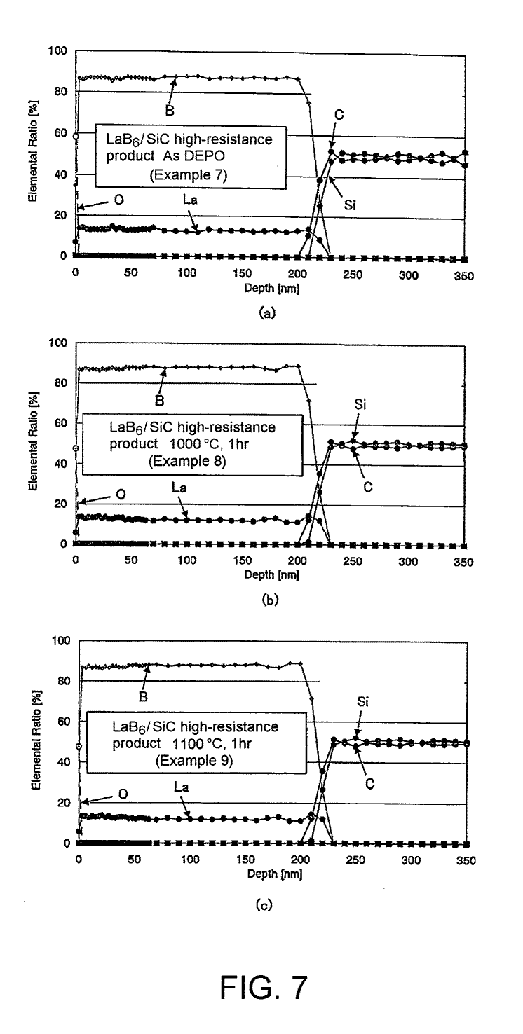

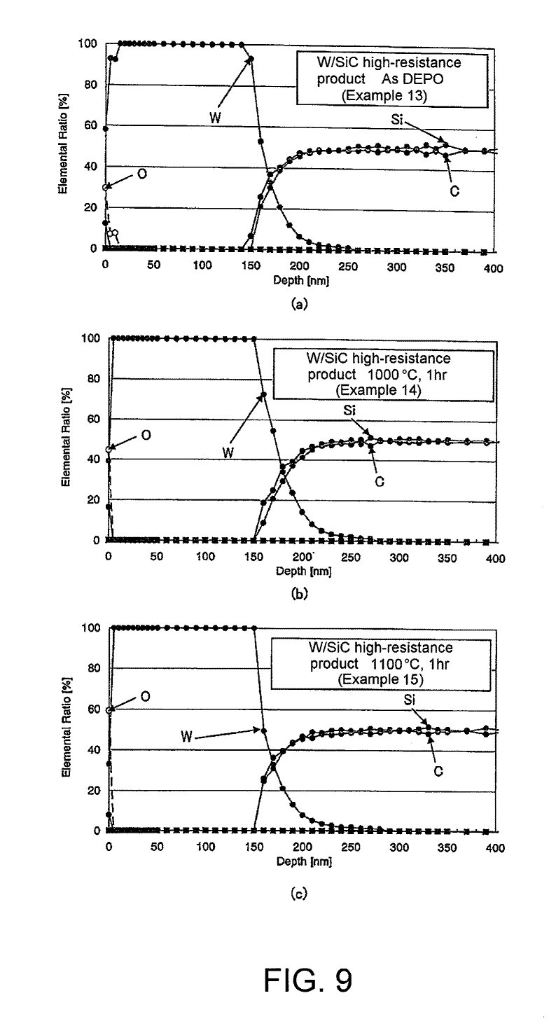

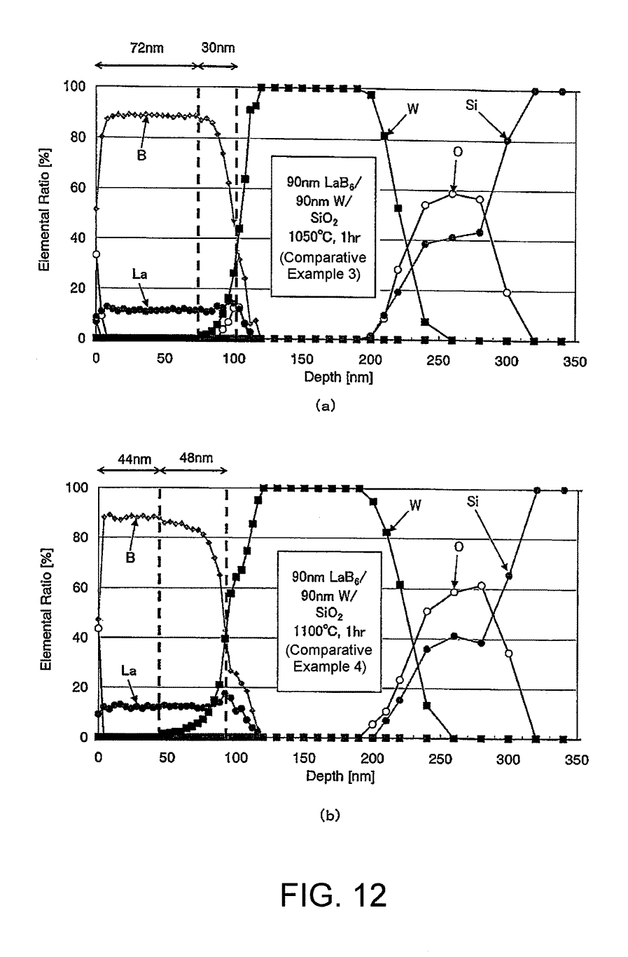

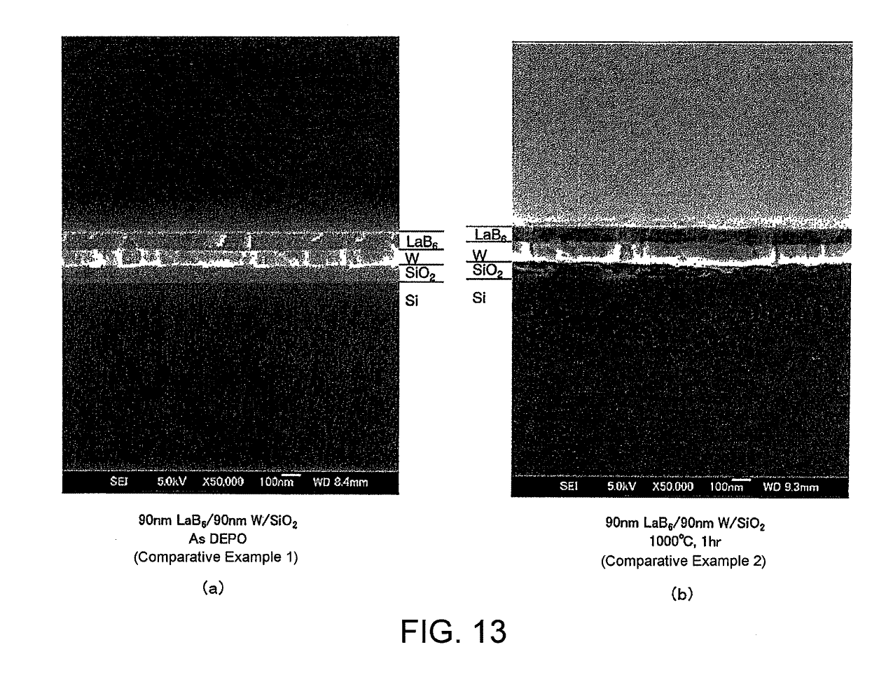

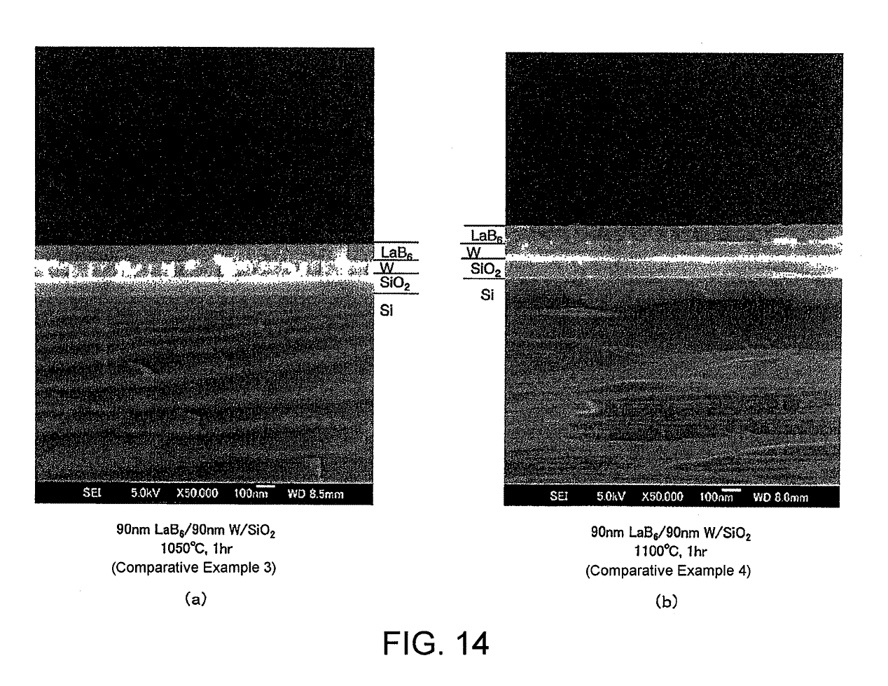

FIGS. 3, 5, and 7 to 12 show composition analysis results of the samples of Examples 1 to 18 and Comparative Examples 1 to 4. FIGS. 4, 6, 13, and 14 show observation results of cross-sections of Examples 1 to 6 and Comparative Examples 1 to 4. Further, Table 1 shows the thickness of LaB₆-W diffusion layers of Comparative Examples 1 to 4.

TABLE 1

| | | Heat | LaB₆ | LaB₆-W | Total |
|---|---|---|---|---|---|
| Film | | Treatment | Layer | Layer | Thick- |
| Structure | Sample No. | Condition | Thickness | Thickness | ness |
| LaB₆/W/ | Comparative | As DEPO | 120 nm | 5 nm | 125 nm |
| SiO₂/Si | Example 1 | | | | |
| | Comparative | Ar, 2SLM, | 80 nm | 26 nm | 106 nm |
| | Example 2 | 1000° C., | | | |
| | | 1 hr | | | |
| | Comparative | Ar, 2SLM, | 72 nm | 30 nm | 102 nm |
| | Example 3 | 1050° C., | | | |
| | | 1 hr | | | |
| | Comparative | Ar, 2SLM, | 44 nm | 48 nm | 92 nm |
| | Example 4 | 1100° C., | | | |
| | | 1 hr | | | |

As is clear from FIGS. 3 to 10, diffusion of the elements between LaB₆ and SiC and diffusion of the elements between W and SiC hardly occurred or even if it occurred, the diffusion depth was constant regardless of the annealing temperature.

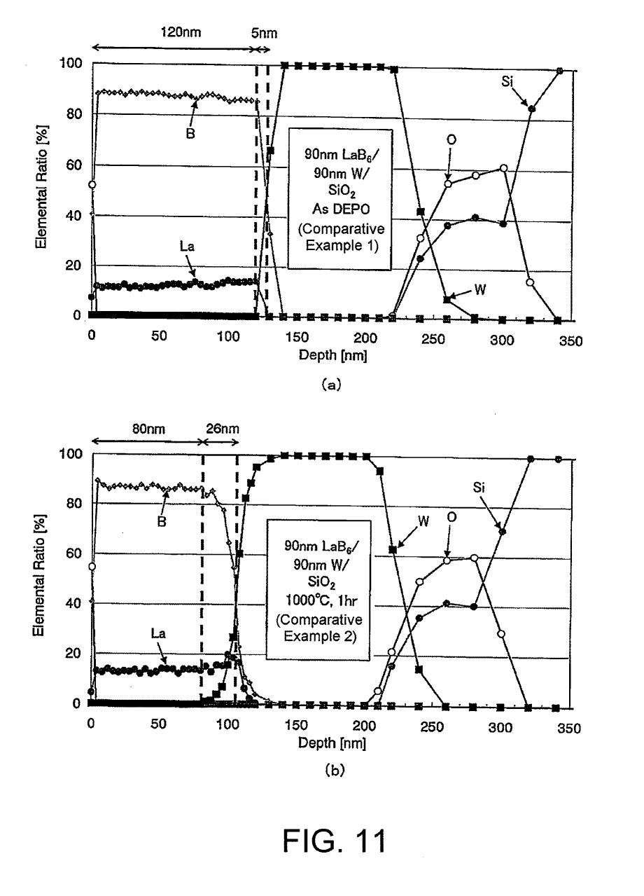

On the other hand, as shown in FIGS. 11 to 14 and Table 1, when SiC was not provided, diffusion of the elements between LaB₆ and W proceeded as the annealing temperature rose and, at 1100° C., the thickness of the diffusion layer exceeded the thickness of the LaB₆ single layer.

Specifically, while the thickness of the diffusion layer was 5 nm and the thickness of the LaB₆ single layer was 120 nm in the sample which was not annealed (the sample described as “As DEPO”), as the annealing temperature rose to 1000° C., 1050° C., and 1100° C., the thickness of the diffusion layer was increased to 26 nm, 30 nm, and 48 nm and conversely the thickness of the LaB₆ single layer was reduced to 80 nm, 72 nm, and 44 nm.

From the results described above, it was seen that SiC could be suitably used as a diffusion preventing layer (barrier layer 303) between LaB₆ and W.

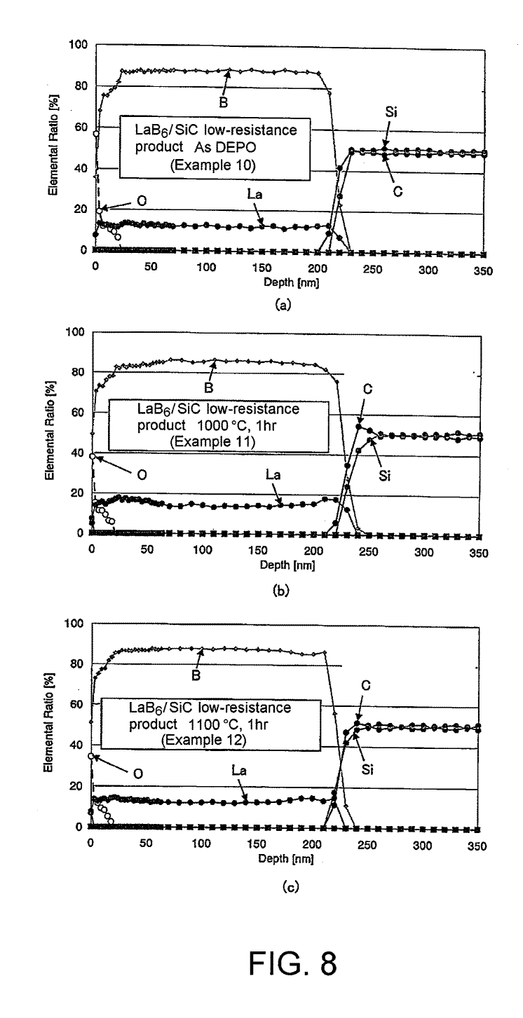

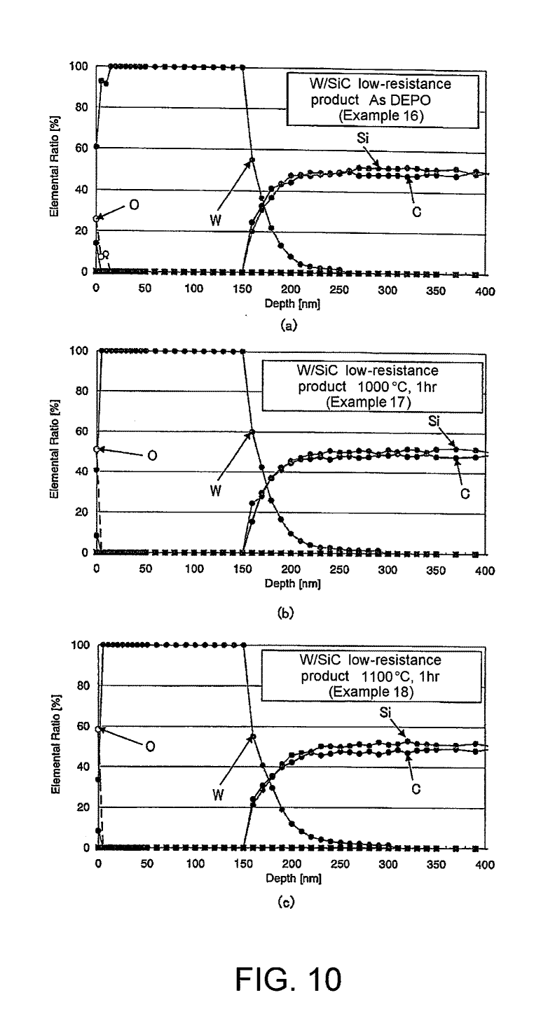

Using a rotary magnet type magnetron sputtering apparatus, a SiC sintered body (low-resistance product) was set as a target and sputtering was carried out at a pressure of 15 mTorr and at a substrate stage temperature of 300° C. while introducing argon at a gas flow rate of 2 SLM into a process chamber space, thereby forming a SiC film to 200 nm on a Si substrate formed with a SiO₂ oxide film. Using this as a SiC substrate, a LaB₆ layer was formed on the SiC substrate in the same manner as in Examples 10 to 12 and a W layer was formed on the SiC substrate in the same manner as in Examples 16 to 18. Measurement was carried out in the same manner as described above and, as a result, the same results as in FIGS. 8 and 10 were obtained, respectively.

### INDUSTRIAL APPLICABILITY

In the above-mentioned embodiment, the description has been given of the case where the cylindrical cup 30 composed mainly of tungsten is used as the base member and the LaB₆ film is formed by sputtering after forming the barrier layer containing SiC on the surface of the base member, and given of the cathode body thus obtained. However, this invention is not limited to the base member of the cylindrical shape and can be applied to base members of various shapes.

The base member according to this invention is not limited to tungsten. It may be molybdenum, silicon, or tungsten or molybdenum containing 4 to 6 wt % lanthanum oxide or may be tungsten or molybdenum containing 4 to 6% La₂O₃ by volume ratio. Further, the base member may be a resin, a glass, or silicon oxide.

The base member may be tungsten, molybdenum, silicon, or tungsten or molybdenum containing at least one selected from the group consisting of

La₂O₃, ThO₂, and Y₂O₃.

On the other hand, the cathode body according to this invention is not limited to the LaB₆ film and is satisfactory if it contains a boride of another rare earth element, such as at least one boride selected from the group consisting of LaB₄, YbB₆, GaB₆, and CeB₆.

This invention is applicable to fluorescent tubes comprising these cathode bodies, respectively.

### DESCRIPTION OF SYMBOLS

1 target
2 columnar rotary shaft
3 rotary magnet group
4 fixed outer peripheral plate magnet
5 outer peripheral paramagnetic member
6 backing plate
7 housing
8 coolant passage
9 insulating member
11 process chamber space
12 feeder line
13 cover
14 outer wall
15 paramagnetic member
16 plasma shielding member
18 slit
19 cathode body manufacturing jig
30 cylindrical cup
301 cylindrical electrode portion
302 lead portion
303 barrier layer
321 receiving portion
322 flange portion
323 inclined portion
341 thick LaB₆ film
342 thin LaB₆ film
343 bottom LaB₆ film

1. A cathode body by comprising:
a base member;
a barrier layer provided on a surface of the base member and containing SiC; and
a film formed on a surface of the barrier layer and containing a boride of a rare earth element.

2. The cathode body according to claim 1, wherein:
the base member is tungsten, molybdenum, silicon, or tungsten or molybdenum containing at least one selected from the group consisting of La₂O₃, ThO₂, and Y₂O₃.

3. The cathode body according to claim 1, wherein:
the boride of the rare earth element contains at least one boride selected from the group consisting of LaB₄, LaB₆, YbB₆, GaB₆, and CeB₆.

4. The cathode body according to claim 3, wherein:
the at least one boride of the rare earth element selected is LaB₆.

5. The cathode body according to claim 4, wherein:
the base member is tungsten or tungsten containing 4 to 6% La₂O₃ by volume ratio.

6. A fluorescent tube using, as a cathode, the cathode body according to claim 1.

7. A method of manufacturing a cathode body, comprising:
a step (a) of forming a barrier layer containing SiC on a surface of a base member; and
a step (b) of forming a film containing a boride of a rare earth element on the barrier layer.

8. The method of manufacturing a cathode body according to claim 7, wherein:
the step (a) is a step of forming the barrier layer on the surface of the base member by CVD or sputtering.

9. The method of manufacturing a cathode body according to claim 7, wherein:
the step (b) is a step of forming the film of LaB₆ on the barrier layer by sputtering.

10. The method of manufacturing a cathode body according to claim 7, wherein:
the base member is tungsten, molybdenum, silicon, or tungsten or molybdenum containing 4 to 6 wt % lanthanum oxide.

11. The cathode body according to claim 3, wherein:
the base member is tungsten, molybdenum, silicon, or tungsten or molybdenum containing at least one selected from the group consisting of La₂O₃, ThO₂, and Y₂O₃.

12. The method of manufacturing a cathode body according to claim 8, wherein:
the step (b) is a step of forming the film of LaB₆ on the barrier layer by sputtering.

13. The method of manufacturing a cathode body according to claim 8, wherein:
the base member is tungsten, molybdenum, silicon, or tungsten or molybdenum containing 4 to 6 wt % lanthanum oxide.
